(19) United States
(12) Patent Application Publication
(10) Pub. No.: US 2024/0308741 A1
(43) Pub. Date: Sep. 19, 2024

(54) PAPER OR PAPERBOARD BASED PACKAGING LAMINATE

(71) Applicant: Stora Enso OYJ, Helsinki (FI)

(72) Inventors: Chris Bonnerup, Floda (SE); Kaj Backfolk, Lappeenranta (FI); Fredrik Werner, Hammarö (SE)

(73) Assignee: Stora Enso OYJ, Helsinki (FI)

(21) Appl. No.: 18/578,479

(22) PCT Filed: Jul. 7, 2022
(86) PCT No.: PCT/IB2022/056289

§ 371 Date: Jan. 11, 2024

(30) Foreign Application Priority Data
Jul. 12, 2021 (SE) 2150925-2

(51) Int. Cl. B65D 65/40; B32B 27/10; B32B 27/30; B32B 27/32; B32B 29/00

(52) U.S. Cl. CPC B65D 65/40; B32B 27/10; B32B 27/306; B32B 27/32; B32B 29/005; B32B 2255/10; B32B 2255/12; B32B 2255/205; B32B 2255/26; B32B 2255/28; B32B 2264/10; B32B 2307/718; B32B 2307/7244; B32B 2307/7246; B32B 2439/00; B32B 2553/00; B65D 2565/383; B65D 2565/387

(57) ABSTRACT

A paper or paperboard based packaging laminate comprising: a paper or paperboard base layer, a mineral coating layer, a PVOH coating layer, and a metallized film layer, wherein the mineral coating layer is arranged between and in contact with the base layer and the PVOH coating layer, and wherein the metallized film layer is laminated to the PVOH coating layer, and wherein the packaging laminate has an oxygen transfer rate (OTR), measured according to the standard ASTM F-1927 at 90% relative humidity and 38° C., of less than 5 cc/m²/day. Also a container with such a paper or paperboard based packaging laminate.

### TECHNICAL FIELD

The present disclosure relates paper and paperboard based packaging materials. More specifically, the present disclosure relates to paper and paperboard based packaging laminates having a low and consistent oxygen transmission rate (OTR) at high relative humidities (RH).

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board. In liquid packaging board, polyolefin coatings are frequently used as liquid barrier layers, heat sealing layers and adhesives. However, the recycling of such polymer coated board is difficult since it is difficult to separate the polymers from the fibers.

Also, in many cases the gas barrier properties of the polymer coated paperboard are still insufficient unless the coating layers are thick or combinations of different polymer coating layers are used. Therefore, in order to ensure high gas and light barrier properties and high stiffness, the polymer coated paperboard is often provided with one or more layers of aluminum foil. However, the addition of polymer and aluminum layers add significant costs and makes recycling of the materials more difficult. Also, due to its high carbon footprint there is a wish to replace aluminum foils in paper and paperboard based packaging materials.

Aseptic packaging for long shelf-life products such as milk and juices are usually made from liquid packaging board (LPB) comprising a multilayer paperboard based substrate, an outermost heat-sealable polyolefin (e.g. polyethylene, PE) layer and innermost layers of polyolefin and aluminum. The aluminum layer, needed to provide oxygen barrier properties, is usually incorporated between layers of polyethylene to provide the following structure: PE/paperboard/PE/aluminum/PE.

In the prior art, attempts have been made to replace the aluminum foil with more environmentally friendly and/or easier to recycle solutions, but so far with no real success.

More recently, microfibrillated cellulose (MFC) films and coatings have been developed, in which defibrillated cellulosic fibrils have been dispersed e.g. in water and thereafter re-organized and rebonded together to form a dense film with excellent gas barrier properties. Unfortunately, the gas barrier properties of such MFC films tend to deteriorate at and high humidity.

Thus, there remains a need for improved solutions to replace plastic films and aluminum foils in paper and paperboard based packaging materials, while maintaining acceptable liquid and oxygen barrier properties. At the same time, there is a need to replace the plastic films and aluminum foils with alternatives that facilitate re-pulping and recycling of the used packaging materials.

### DESCRIPTION OF THE INVENTION

It is an object of the present disclosure to provide an alternative to the plastic films and aluminum foils commonly used as barrier films for providing oxygen barrier properties in packaging materials, such as liquid packaging board.

It is a further object of the present disclosure, to provide a paper or paperboard based packaging laminate, such as a liquid packaging board, which provides good oxygen barrier properties even at higher relative humidity and temperature.

It is a further object of the present disclosure to provide a paper or paperboard based packaging laminate, which has an oxygen transfer rate (OTR), measured according to the standard ASTM F-1927 at 90% relative humidity and 38° C., of less than 5 cc/m²/day.

It is a further object of the present disclosure to provide a paper or paperboard based packaging laminate, such as a liquid packaging board, comprising an oxygen barrier layer which facilitates re-pulping of the board as compared to packaging laminates using conventional plastic films and aluminum foils.

It is a further object of the present disclosure to provide a paper or paperboard based packaging laminate having a reject rate according to PTS RH 021/97 of less than 30%, preferably less than 20%.

The above-mentioned objects, as well as other objects as will be realized by the skilled person in the light of the present disclosure, are achieved by the various aspects of the present disclosure.

According to a first aspect illustrated herein, there is provided a paper or paperboard based packaging laminate comprising:
a paper or paperboard base layer,
a mineral coating layer,
a PVOH coating layer, and
a metallized film layer,
wherein the mineral coating layer is arranged between and in contact with the base layer and the PVOH coating layer, and
wherein the metallized film layer is laminated to the PVOH coating layer, and
wherein the packaging laminate has an oxygen transfer rate (OTR), measured according to the standard ASTM F-1927 at 90% relative humidity and 38° C., of less than 5 cc/m²/day.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

A paper or paperboard based packaging laminate is a packaging material formed mainly, or entirely from paper or paperboard. It can be made from pulp, including pulp from virgin fiber, e.g. mechanical, chemical and/or thermomechanical pulps. It can also be made from broke or recycled paper. In addition to paper or paperboard, the paper or paperboard based packaging laminate may comprise additional layers or coatings designed to improve the performance and/or appearance of the packaging laminate.

The paper or paperboard based packaging laminate typically has a first outermost surface intended to serve as the outside surface, or print side, and a second outermost surface intended to serve as the inside surface of a packaging container. The side of the paper or paperboard base layer comprising the metallized film layer is intended to serve as the inside surface of a packaging container.

The inventive packaging laminate layer can provide both excellent oxygen barrier properties, water vapor barrier properties, and liquid barrier properties. Especially useful is the combination of high oxygen barrier properties and high water vapor barrier properties at high humidity and temperature enabled by the combination of the PVOH layer and the metallized film layer. The term high humidity in the context of the present disclosure generally refers to a relative humidity (RH) above 80%. The term high temperature in the context of the present disclosure generally refers to a temperature above 23° C. More specifically, the term high temperature in the context of the present disclosure may refer to a temperature in the range of 25-50° C. Oxygen barrier and water vapor barrier properties of the packaging laminates at high humidity and temperature are typically measured at a representative relative humidity (RH) of 90% and a temperature of 38° C.

The inventive packaging laminate has an oxygen transfer rate (OTR), measured according to the standard ASTM F-1927 at 90% relative humidity and 38° C., of less than 5 cc/m²/day. This makes the inventive packaging laminate an interesting and viable alternative to conventional materials using aluminum foil layers.

Additionally, the inventive paper or paperboard based packaging laminate can provide an alternative to conventional materials using aluminum foil layers, which can more readily be repulped and recycled. The inventive paper or paperboard based packaging laminate comprises a mineral coating layer arranged between and in contact with the base layer and the PVOH coating layer. The inventive combination of the mineral coating layer and the PVOH coating layer has been found to allow for effective separation of the metallized film layer from the base layer during repulping. In addition, the mineral coating layer counteracts undesired migration of PVOH into the base layer and may protect the PVOH coating against water vapor. In some embodiments, the paper or paperboard based packaging laminate has a reject rate according to PTS RH 021/97 of less than 30%, preferably less than 20%, more preferably less than 10%.

In some embodiments, the mineral coating layer comprises
50-95 wt % of a particulate mineral, and
5-50 wt % of a binder,
based on the total dry weight of the mineral coating layer.

In some embodiment, the mineral coating layer comprises 10-35 wt % binder.

In some embodiments, the mineral coating layer comprises
10-35 wt %, preferably 10-20 wt %, binder and
90-65 wt %, preferably 90-80 wt %, particulate mineral
based on the total dry weight of the mineral coating layer.

The high amount of particulate mineral in the mineral coating layer enhances the release of the metallized film layer from the base layer during repulping.

In some embodiments, the particulate mineral is selected from the group consisting of kaolin, calcium carbonate, bentonite, talc, and combinations thereof, preferably kaolin or calcium carbonate, and more preferably kaolin.

In some embodiment, the particulate mineral comprises 80-100 wt % calcium carbonate and 0-20 wt % clay, as calculated on the dry weight of the total particulate mineral in the mineral coating layer. The use of a high amount of calcium carbonate with low shape factor in the mineral coating layer enables higher solid contents and a lower amount of binder in the coating layer while a good coverage may still be obtained. The low amount of binder, in turn, enhances the release of the metallized film layer. Preferably, the shape factor of the calcium carbonate is less than 10, preferably between 0.1-10, or 0.1-5. “Shape factor” as used herein is a measure of an average value (weight) of the ratio of mean particle diameter to particle thickness and can be measured using electrical conductivity method. Moreover, calcium carbonate is not as reactive as clay, which makes it easier to dissolve in acid environments, thereby facilitating the recycling process even further.

The calcium carbonate used has preferably a low surface area, preferably below 20 m²/g, more preferably below 15 m²/g, such as between 3-20 m²/g or 3-15 m²/g. In comparison with clay, it is easier to recycle pigments with such low surface area, particularly less chemicals are needed in the recycling. The “surface area” as used herein is measured by adsorption using the BET isotherm (ISO 9277:2010).

In embodiments, the calcium carbonate contained in the particulate mineral is a mixture of a first calcium carbonate comprising between 50-70 weight percent of particles with a particle size of less than 2 μm and a second calcium carbonate comprising between 80-100 weight percent of particles with a particle size of less than 2 μm. The particle size may be measured using a Mastersizer 2000. Preferably, the first calcium carbonate has a median particle size by weight (d50) of between 1-2 μm and the second calcium carbonate has a median particle size by weight (d50) of between 0.5-0.9 μm. In a preferred embodiment, the mineral coating layer comprises 20-40 wt %, preferably 20-30 wt %, of said first calcium carbonate and 80-60 wt %, preferably 80-70 wt % of said second calcium carbonate, as calculated on the total dry weight of calcium carbonate in the mineral coating layer.

In embodiments, the particulate mineral comprises 80-90 wt % calcium carbonate and 10-20 wt % clay, as calculated on the dry weight of the total particulate mineral in the mineral coating layer. Such a particulate mineral mixture is optimized to provide both high barrier properties and excellent recyclability.

The binder may be a water-dispersible or water-soluble binder. In some embodiments, the water-dispersible binder is a latex binder. In some embodiments, the water-soluble binder is a starch, PVOH, a cellulose derivate such as CMC, a protein, or seaweed. An advantage of using a water-soluble binder is that the laminate will be even more easy to recycle.

In some embodiments, the grammage of the mineral coating layer is in the range of 4-25 g/m², more preferably in the range of 6-20 g/m².

The mineral coating layer may preferably be applied in at least two different coating steps with drying of the coated film between the steps.

The PPS (Parker Print-Surf) smoothness according to ISO 8791-4 of the mineral coating layer is preferably less than 5 μm. The Cobb-Unger value (30s, bs) of the mineral coating layer is preferably less than 20 g/m², preferably in the range of 1-20 g/m², and more preferably in the range of 5-15 g/m², wherein the Cobb-Unger value is a measure of the oil absorption and measured by the SCAN-P 37:77 (30 seconds) method.

The inventive packaging laminate comprises a polyvinyl alcohol (PVOH) coating layer. The PVOH coating layer is arranged between the mineral coating layer and the metallized film layer. In some embodiments the PVOH coating layer is in direct contact with the mineral coating layer. The PVOH coating layer may be applied to the mineral coating layer before the metallized film layer is laminated to the PVOH coating layer.

The PVOH of the PVOH coating layer is soluble in cold water or soluble in water after heating to a temperature below 100° C. for a given period of time. The water solubility of the PVOH coating layer improves the separation of the metallized film layer from the base layer during repulping. The PVOH may for example have a degree of hydrolysis in the range of 80-99 mol %, preferably in the range of 85-98 mol %. The crystallinity of the PVOH is preferably less than 0.6, preferably less than 0.5, and more preferably less than 0.4 as determined by wide-angle x-ray scattering.

In some embodiments, the PVOH coating layer comprises at least 50 wt % PVOH, preferably at least 70 wt % PVOH, based on the total dry weight of the PVOH coating layer.

The PVOH may be an unmodified PVOH or a modified PVOH. The modified PVOH may preferably be an ethylene modified PVOH.

The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPa×s in a 4% aqueous solution at 20° C. DIN 53015/JIS K 6726 (with no additives and with no change in pH, i.e. as obtained when dispersed and dissolved e.g. in distilled water). Examples of useful products are, e.g., Kuraray Poval 4-98, Poval 6-98, Poval 10-98, Poval 20-98, Poval 30-98, or Poval 56-98 or mixtures of these. From the less hydrolysed grades, Poval 4-88, Poval 6-88, Poval 8-88, Poval 18-88, Poval 22-88, or e.g. Poval 49-88 are preferred. Alternatively, fully hydrolyzed grades (98-99.9%) of PVOH may also be used. The PVOH preferably has an ash content of less than 0.9 wt %, preferably less than 0.7 wt %, less than 0.4 wt % or less than 0.2 wt %.

To minimize the risk of pinholes in the PVOH coating layer, the PVOH coating layer may preferably be applied in at least two different coating steps with drying of the coated film between the steps. In some embodiments, the PVOH coating layer is multilayered and at least one layer contains a low molecular weight PVOH. This will further facilitate subsequent release of the metallized film layer from the paper or paperboard base layer during repulping.

The PVOH coating layer is preferably formed by means of a liquid film coating process, i.e. in the form of an aqueous solution or dispersion which, on application, is spread out to a thin, uniform layer on a substrate and thereafter dried. The PVOH coating layer can be applied by contact or non-contact coating methods. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating.

In some embodiments, at least one PVOH coating layer is applied in the form a foam. Foam coating is advantageous as it allows for film forming at higher solids content and lower water content compared to an unfoamed coating. The lower water content of a foam coating also reduces the problems with rewetting of the substrate. The foam may be formed using a polymeric or non-polymeric foaming agent. Examples of polymeric foaming agents include PVOH, hydrophobically modified starch, and hydrophobically modified ethyl hydroxyethyl cellulose.

The basis weight of the PVOH coating layer may generally be in the range of 1-20 g/m². In some embodiments, the grammage of the PVOH coating layer is in the range of 2-15 g/m², more preferably in the range of 3-12 g/m².

In some embodiments, a cross-linking agent is added to the mineral coating layer and/or to the PVOH coating layer. A cross-linking agent can improve water resistance and the adhesion at the mineral coating-PVOH coating interface. Suitable cross-linking agents include, but are not limited to, glyoxal, citric acid, glutaraldehyde. The concentration of the cross-linking agent may for example be 1-20 wt %, preferably 1-15 wt %, based on the mineral layer or PVOH weight. A cross-linking agent solution may also be applied on top of the mineral coating layer before forming the PVOH coating layer, in order to increase the cross-linking at the interface between the mineral coating layer and the PVOH coating layer.

The inventive paper or paperboard based packaging laminate comprises a metallized film layer laminated to the PVOH coating layer. The metallized film layer preferably further improves the oxygen barrier and/or water vapor barrier properties of the laminate.

The metallized film layer comprises a substrate film and a metallization layer applied to at least one surface of said substrate film.

The metallized film layer preferably comprises a metallized polymer film or a metallized cellulose-based film. The combination of the metallized polymer film and the PVOH coating layer further improves the barrier properties of the laminate and protects both the PVOH coating layer and the metallization layer from cracking at the converting of the laminate. A metallized cellulose-based film may also improve the barrier properties of the laminate and makes the laminate more recyclable.

The substrate film of the present invention may be any substrate film suitable for applying a continuous of substantially continuous vacuum coating layer having a thickness in the range of 1-500 nm thereon. The substrate film preferably comprises a film or sheet shaped material having a smooth, dense and relatively low porous surface on which the vacuum coating can be applied. The substrate film should preferably have few or no pinholes. The amount of pinholes in a film or sheet shaped substrate film may for example be determined according to standard EN13676:2001. The substrate film preferably comprises less than 10 pinholes/m², preferably less than 8 pinholes/m², and more preferably less than 2 pinholes/m². The amount of pinholes per m² may for example be measured by optical inspection, for example according to standard EN13676:2001. The substrate film preferably has a Gurley Hill porosity greater than 30 000 s/100 m², preferably greater than 40 000 s/100 m², as measured according to standard ISO 5636/5. The OTR of the substrate film may be >5 cc/m²/day, such as >10 cc/m²/day or >20 cc/m²/day, determined at 23° C. and 50% RH. The thickness of the substrate film is typically in the range of 10-100 μm, preferably in the range of 15-80 μm, and more preferably in the range of 20-60 μm. The density of the substrate film is typically >850 kg/m³ or >900 kg/m³ or >950 kg/m³ or >1000 kg/m³, preferably in the range of 1050-1250 kg/m³.

The substrate film may consist of a single layer of material or it can be a multilayer structure comprised of two or more layers of the same or different materials. The substrate film may for example comprise or consist of a polymer film formed from synthetic or biobased polymers. Alternatively, the substrate film may comprise or consist of a dense sheet of a fiber based material. The substrate film may also comprise or consist of a combination of a fiber based material and a synthetic or biobased polymer, e.g. in the form of a laminate or a polymer coated paper or a composite. In some embodiments the substrate film comprises or consists of a mixture of fibers and a polymer. In some embodiments the substrate film comprises one layer of a fiber based material and one layer of a polymer. For example, the substrate film can consist of a fiber based layer, for example a microfibrillated cellulose (MFC) film, coated with a polymer layer, for example a polyvinyl alcohol (PVOH) coating to improve the smoothness and decrease the porosity of the MFC film surface.

In some embodiments, the substrate film is a polymer film. The polymer of the polymer film may for example be selected from the group consisting of polyolefins, such as polyethylene or polypropylene, polyesters, such as PET, polyimides, fluoropolymers, and PEEK.

In a preferred embodiment, the polymer of the polymer film is a biaxially oriented polypropylene (BOPP) film. BOPP film is preferred for use in food packaging applications, e.g. due to its high moisture resistance, optical clarity and high tensile strength. Preferably, the BOPP film comprises at least 50% recycled PP or PP based on renewable resources.

There is a demand for improved solutions to replace aluminum foils and polyolefin films as barrier layers in packaging laminates, such as liquid packaging board, with alternatives that facilitate re-pulping and recycling of the used packaging laminates.

The substrate film is preferably biobased and more preferably cellulose based. By biobased or cellulose based is meant that more than 50% by weight of the substrate film is of natural, or preferably cellulosic origin. Using a cellulose based substrate film is especially useful for barrier films for use in paper or paperboard laminates since the laminate can be recycled as a single material.

The metallized film layer can advantageously be manufactured almost entirely from biobased materials, and preferably from cellulose based materials, thereby facilitating re-pulping and recycling of used paper and paperboard based packaging laminates. Such packaging materials, containing 95% by weight or more of cellulosic material, with the remaining 5% being other materials that will not affect recycling of the packaging material, are sometimes referred to as monomaterials. Thus, in some embodiments, more than 95% by weight of the metallized film layer is cellulose based.

In some embodiments, the substrate film comprises a high density paper, such as a supercalandered paper or a machine glazed paper formed from chemical pulp or mechanical pulp or a mixture thereof.

In some embodiments, the substrate film comprises a high density paper, such as a supercalandered paper formed from chemical pulp or mechanical pulp or a mixture thereof, which has subsequently been coated or laminated with a MFC film or layer to provide a surface suitable for applying a continuous of substantially continuous vacuum coating layer having a thickness in the range of 1-500 nm thereon.

In some embodiments, the substrate film comprises a regenerated cellulose film, for example cellophane.

Microfibrillated cellulose (MFC) has been identified as an interesting component for use in barrier films for paper and paperboard packaging materials. In some embodiments, the substrate film consists of or comprises an MFC film. In other words, the substrate can be made up entirely of the MFC film, or it can include the MFC film as one of several layers.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

A fibrous or porous substrate film, e.g. a MFC film, may preferably be combined with a surface treatment to improve the smoothness and decrease the porosity of the substrate surface and make the surface more suitable for metallization. Possible surface treatments include, but are not limited to providing the surface with a smoothening precoat or mechanical smoothening, e.g. by calandering.

The surface treatment may for example include applying a precoat or primer layer to the fibrous or porous substrate layer. The precoat layer preferably acts to level out unevenness, and fill pores and pinholes present in the fibrous or porous substrate film. The surface treatment may also include subjecting the substrate surface to corona or plasma treatment in order to improve adhesion.

Calandering may include hard nip or soft nip calandering in one or several passes or nips. The mechanical smoothening can also be combined with a precoating step, performed before or after the calandering.

Thus, in some embodiments, the metallized film layer further comprises a precoat layer disposed between the substrate film and the vacuum coating layer.

In some embodiments, the precoat layer comprises a water-soluble polymer selected from the group consisting of a polyvinyl alcohol, a modified polyvinyl alcohol, a polysaccharide and a modified polysaccharide, or combinations thereof, preferably polyvinyl alcohol.

The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPa×s in a 4% aqueous solution at 20° C. DIN 53015/JIS K 6726 (with no additives and with no change in pH, i.e. as obtained when dispersed and dissolved e.g. in distilled water). Examples of useful products are, e.g., Kuraray Poval 4-98, Poval 6-98, Poval 10-98, Poval 20-98, Poval 30-98, or Poval 56-98 or mixtures of these. From the less hydrolysed grades, the Poval 4-88, Poval 6-88, Poval 8-88, Poval 18-88, Poval 22-88, or e.g. Poval 49-88 are preferred.

The modified polysaccharide may for example be a modified cellulose, such as carboxymethylcellulose (CMC) or hydroxypropyl cellulose (HPC), or a modified starch, such as a hydroxyalkylated starch, a cyanoethylated starch, a cationic or anionic starch, or a starch ether or a starch ester. Some preferred modified starches include hydroxypropylated starch, hydroxyethylated starch, dialdehyde starch and carboxymethylated starch.

In some embodiments, the basis weight of the precoat layer is in the range of 0.1-12 g/m², preferably in the range of 0.5-8 g/m², more preferably in the range of 1-6 g/m².

To minimize the risk of pinholes in the precoat layer, the precoat layer may preferably be applied in at least two different coating steps with drying of the coated film between the steps.

The precoat layer can be applied by contact or non-contact coating methods. For application on MFC layers, non-contact coating methods are typically preferred to minimize the risk of damage to the substrate during coating. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating. In some embodiments, the coating is applied in the form a foam.

Foam coating is advantageous as it allows for film forming at higher solids content and lower water content compared to an unfoamed coating. The lower water content of a foam coating also reduces the problems with rewetting of the MFC layer.

Metallization refers to a family of processes used to deposit layers of metals or metal oxides atom-by-atom or molecule-by-molecule on a solid surface. Multiple layers of the same or different materials can be combined. The process can be further specified based on the vapor source; physical vapor deposition (PVD) uses a liquid or solid source and chemical vapor deposition (CVD) uses a chemical vapor.

In some embodiments, the metallization layer is formed by vapor deposition of a metal or metal oxide on the substrate film, preferably by physical vapor deposition (PVD) or chemical vapor deposition (CVD).

In some embodiments, only one of the surfaces of the substrate film is metallized. In some embodiments, both surfaces of the substrate film are metallized.

In some embodiments, the metallization layer comprises a metal, a metal oxide or a ceramic oxide selected from the group consisting of aluminum, magnesium, silicon, copper, aluminum oxides, magnesium oxides, silicon dioxides, and combinations thereof, preferably an aluminum oxide. Aluminum oxide vacuum coatings also known as AlOx coatings can provide similar barrier properties as aluminum metal coatings, but have the added advantage of thin AIOx coatings being transparent to visible light.

The metallization layer of the present invention may have a thickness in the range of from 1 to 500 nm. In some embodiments, the metallization layer has a layer thickness in the range of 1-100 nm, preferably in the range of 10-100 nm, and more preferably in the range of 20-50 nm. In some embodiments, the metallization layer has a basis weight in the range of 50-250 mg/m², preferably in the range of 75-150 mg/m².

One preferred type of metallization coating, often used for its barrier properties, in particular water vapour barrier properties, is an aluminum metal physical vapour deposition (PVD) coating. Such a coating, substantially consisting of aluminum metal, may typically have a thickness of from 10 to 50 nm. The thickness of the metallization layer corresponds to less than 1% of the aluminum metal material typically present in an aluminum foil of conventional thickness for packaging, i.e. 6.3 μm.

The grammage of the metallized film layer will depend on the substrate film used. The grammage of the metallized film layer is typically in the range of 1-100 g/m². In some embodiments, the grammage of the metallized film layer is in the range of 10-70 g/m², more preferably in the range of 10-70 g/m². For a metallized polymer film the grammage may typically be at the lower end of the range, such as in the range of 10-30 g/m², whereas for a metallized cellulose based film, the grammage may be higher, such as in the range of 20-100 g/m².

The metallized film layer is laminated to the PVOH coating layer. The metallized film layer may be laminated to the PVOH layer using any suitable means of adhesion.

In some embodiments, the metallized film layer is laminated to the PVOH coating layer using the PVOH of the PVOH layer as an adhesive.

In some embodiments, the metallized film layer is attached to the PVOH coating layer by an adhesive tie layer arranged between the PVOH coating layer and the metallized film layer. The adhesive tie layer may comprise any suitable adhesive for providing or improving lamination adhesion between the PVOH coating layer and the metallized film layer. The tie layer may for example be an extruded polyolefin adhesive, preferably polyethylene, or a dispersion adhesive, preferably a latex or a polyolefin dispersion. In some embodiments, the tie layer may comprise ethylene vinyl acetate (EVA) or polymer acrylate, such as ethylene butyl acrylate. The coat weight of the adhesive tie layer may typically be in the range of 0.5-15 g/m², preferably in the range of 1-12 g/m².

In some embodiments, the adhesive tie layer comprises a polyethylene or an ethylene modified PVOH.

In some embodiments, the paper or paperboard base layer has a basis weight in the range of 20-500 g/m², preferably in the range of 80-400 g/m².

In some embodiments, the paper or paperboard base layer is a multiply paperboard.

The structure of the inventive paper or paperboard based packaging laminate enables the use of a larger amount of recycled fibers in the paper or paperboard base layer since the barrier structure hinders the migration of mineral oil based compounds. Thus, in some embodiments, the paper or paperboard base layer comprises at least 5 wt % recycled fibers, preferably at least 10 wt % recycled fibers.

The paper or paperboard based packaging laminate may further be provided with an outermost protective polymer layer on one side or on both sides.

In some embodiments, the paper or paperboard based packaging laminate further comprises a first protective polymer layer, preferably a polyethylene layer, arranged on the paper or paperboard base layer.

In some embodiments, the paper or paperboard based packaging laminate further comprises a second protective polymer layer, preferably a polyethylene layer, arranged on the metallized film layer.

The protective polymer layers may of course interfere with repulpability but may still be required or desired in some applications. The additional polymer layers may for example be applied by extrusion coating, film lamination or dispersion coating.

The protective polymer layers may comprise any of the thermoplastic polymers commonly used in paper or paperboard based packaging laminates in general or polymers used in liquid packaging board in particular. Examples include polyethylene (PE), polyethylene terephthalate (PET), polypropylene (PP), polyhydroxyalkanoates (PHA), polylactic acid (PLA), polyglycolic acid (PGA), starch and cellulose. Polyethylenes, especially low density polyethylene (LDPE) and high density polyethylene (HDPE), are the most common and versatile polymers used in liquid packaging board.

Thermoplastic polymers, are useful since they can be conveniently processed by extrusion coating techniques to form very thin and homogenous films with good liquid barrier properties. In some embodiments, the additional polymer layer comprises polypropylene or polyethylene. In preferred embodiments, the protective polymer layers comprises polyethylene, more preferably LDPE or HDPE.

In some embodiments, the protective polymer layers are formed by extrusion coating of the polymer onto a surface of the barrier film. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each of the protective polymer layers is preferably less than 50 g/m². In order to achieve a continuous and substantially defect free film, a basis weight of the protective polymer layer of at least 8 g/m², preferably at least 12 g/m² is typically required. In some embodiments, the basis weight of the protective polymer layer is in the range of 8-50 g/m², preferably in the range of 12-50 g/m².

The combination of a metallized film layer and a polyvinyl alcohol (PVOH) layer has been found to provide paper and paperboard packaging laminates with excellent gas barrier properties and water vapor barrier properties.

In some embodiments, the paper or paperboard based packaging laminate has an oxygen transfer rate (OTR), measured according to the standard ASTM F-1927 at 50% relative humidity and 23° C., of less than 5 cc/m²/day, preferably less than 3 cc/m²/day, and more preferably less than 2 cc/m²/day.

In some embodiments, the paper or paperboard based packaging laminate has an oxygen transfer rate (OTR), measured according to the standard ASTM F-1927 at 90% relative humidity and 38° C., of less than 3 cc/m²/day, preferably less than 2 cc/m²/day.

In some embodiments, the paper or paperboard based packaging laminate has a water vapor transfer rate (WVTR), measured according to the standard ASTM F1249 at 50% relative humidity and 23° C., of less than 5 g/m²/day, and preferably less than 0.5 g/m²/day.

In some embodiments, the paper or paperboard based packaging laminate has a water vapor transfer rate (WVTR), measured according to the standard ASTM F1249 at 90% relative humidity and 38° C., of less than 5 g/m²/day, and preferably less than 1 g/m²/day.

There is a demand for improved solutions to replace aluminum foils and polyolefin films as barrier layers in packaging laminates, such as liquid packaging board, with alternatives that facilitate re-pulping and recycling of the used packaging laminates. The combination of a mineral coating layer and a PVOH coating layer according to the present disclosure has been found to facilitate re-pulping and recycling of the used packaging laminates.

In some embodiments, the paper or paperboard based packaging laminate has a reject rate according to PTS RH 021/97 of less than 30%, preferably less than 20%, more preferably less than 10%.

According to a second aspect illustrated herein, there is provided a container, particularly a liquid packaging container, comprising a paper or paperboard based packaging laminate according to the first aspect.

In some embodiments, the metallized film layer faces the inside of the container.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

Four samples were made in accordance with the following:

### Base Board:

3-ply board, 195-281 g/m² with a first surface layer of bleached sulphate pulp, a second surface layer of unbleached sulphate pulp a middle layer of unbleached sulphate pulp and unbleached CTMP.

### Mineral Coating:

The base board was double coated (pre-coat+top coat) with a total coat weight of around 22 g/m² on the first surface layer with mineral coating according to table 1 below:

TABLE 1

| | | Pre coat | Top coat |
|---|---|---|---|
| | | (Parts, dry) | (Parts, dry) |
| Pre coat: | Calcium Carbonate (60) | 30 | 25 |
| | Calcium Carbonate (90) | 70 | 65 |
| | Kaolin 90 | 0 | 10 |
| | SA Latex | 15 | 16 |
| | Additives (thickener, pH | 0.23 | 0.69 |
| | regulating agents, disp. agent) | | |

The mineral coated base board was subsequently coated with a PVOH dispersion coating layer to a coat weight of 5 g/m².

A 18 μm metallized BOPP film (grammage about 16 g/m²) was laminated onto the PVOH coating layer by extrusion lamination with LDPE as tie layer.

Finally, an LLDPE layer was extrusion coated onto the metalized BOPP.

The oxygen transmission rate (OTR) and water vapor transmission rate (WVTR) were measured on the samples (see table 2). As can be seen in table 2, both the OTR and the WTR were very low also at a high temperature and at high humidity.

TABLE 2

| | |
|---|---|
| OTR (ml/(m²*24 h)) | WVTR (g/(m²*24 h)) |

| 23° C. | 38° C. | 23° C. | 38° C. |
|---|---|---|---|
| 50% RH | 90% RH | 50% RH | 90% RH |
| <0.05 to 0.3 | 0.7 to 1.4 | 0.06-0.07 | 0.3-0.4 |

1. A paper or paperboard based packaging laminate comprising:
a paper or paperboard base layer,
a mineral coating layer,
a polyvinyl alcohol (PVOH) coating layer, and
a metallized film layer,
wherein the mineral coating layer is arranged between and in contact with the base layer and the PVOH coating layer, and
wherein the metallized film layer is laminated to the PVOH coating layer, and
wherein the packaging laminate has an oxygen transfer rate (OTR), measured according to the standard ASTM F-1927 at 90% relative humidity and 38° C., of less than 5 cc/m²/day.

2. The paper or paperboard based packaging laminate according to claim 1, wherein the mineral coating layer comprises
65-90 wt % of a particulate mineral, and
10-35 wt % of a binder,
based on a total dry weight of the mineral coating layer.

3. The paper or paperboard based packaging laminate according to claim 2, wherein the particulate mineral is selected from a group consisting: of kaolin, calcium carbonate, bentonite, talc, and combinations thereof.

4. The paper or paperboard based packaging laminate according to claim 3, wherein the mineral coating layer comprises 80-100 wt % calcium carbonate and 0-20 wt % clay, as calculated on a dry weight of a total particulate mineral in the mineral coating layer.

5. The paper or paperboard based packaging laminate according to claim 4, wherein the calcium carbonate comprises a mixture of a first calcium carbonate comprising between 50-70 wt % of particles with a particle size of less than 2 μm and a second calcium carbonate comprising between 80-100 wt % of particles with a particle size of less than 2 μm.

6. The paper or paperboard based packaging laminate according to claim 2, wherein the binder is a latex binder.

7. The paper or paperboard based packaging laminate according to claim 1, wherein the grammage of the mineral coating layer is in the range of 4-25 g/m².

8. The paper or paperboard based packaging laminate according to claim 1, wherein the PVOH coating layer comprises at least 70 wt % PVOH, based on a total dry weight of the PVOH coating layer.

9. The paper or paperboard based packaging laminate according to claim 1, wherein a grammage of the PVOH coating layer is in a range of 1-20 g/m².

10. The paper or paperboard based packaging laminate according to claim 1, wherein the metallized film layer comprises a metallized polymer film or a metallized cellulose-based film.

11. The paper or paperboard based packaging laminate according to claim 1, wherein more than 95% by weight of the metallized film layer is cellulose based.

12. The paper or paperboard based packaging laminate according to claim 1, wherein the metallized film layer comprises a metallization layer formed by vapor deposition of a metal or metal oxide on the film layer.

13. The paper or paperboard based packaging laminate according to claim 12, wherein the metallization layer comprises a metal, a metal oxide or a ceramic oxide selected from a group consisting of aluminum, magnesium, silicon, copper, aluminum oxides, magnesium oxides, silicon oxides, and combinations thereof.

14. The paper or paperboard based packaging laminate according to claim 10, wherein the metallization layer has a layer thickness in the range of 1-100 nm, preferably in the range of 10-100 nm.

15. The paper or paperboard based packaging laminate according to claim 1, wherein a grammage of the metallized film layer is in a range of 10-70 g/m².

16. The paper or paperboard based packaging laminate according to claim 1, wherein the metallized film layer is attached to the PVOH coating layer by an adhesive tie layer.

17. The paper or paperboard based packaging laminate according to claim 16, wherein the adhesive tie layer comprises a polyethylene or an ethylene modified PVOH.

18. The paper or paperboard based packaging laminate according to claim 1, wherein the paper or paperboard base layer has a basis weight in a range of 20-500 g/m².

19. The paper or paperboard based packaging laminate according to claim 1, wherein the paper or paperboard base layer is a multiply paperboard.

20. The paper or paperboard based packaging laminate according to claim 1, wherein the paper or paperboard base layer comprises at least 5 wt % recycled fibers.

21. The paper or paperboard based packaging laminate according to claim 1, further comprising:
a protective polymer layer arranged on the paper or paperboard base layer.

22. The paper or paperboard based packaging laminate according to claim 1, further comprising:
a protective polymer layer arranged on the metallized film layer.

23. The paper or paperboard based packaging laminate according to claim 1, having an oxygen transfer rate (OTR), measured according to the standard ASTM F-1927 at 50% relative humidity and 23° C., of less than 5 cc/m²/day.

24. The paper or paperboard based packaging laminate according to claim 1, having an oxygen transfer rate (OTR), measured according to the standard ASTM F-1927 at 90% relative humidity and 38° C., of less than 3 cc/m²/day.

25. The paper or paperboard based packaging laminate according to claim 1, having a water vapor transfer rate (WVTR), measured according to standard ASTM F1249 at 50% relative humidity and 23° C., of less than 5 g/m²/day.

26. TheA paper or paperboard based packaging laminate according to claim 1, having a water vapor transfer rate (WVTR), measured according to standard ASTM F1249 at 90% relative humidity and 38° C., of less than 5 g/m²/day.

27. The paper or paperboard based packaging laminate according to claim 1, having a reject rate according to PTS RH 021/97 of less than 30%.

28. A container comprising:
the paper or paperboard based packaging laminate according to claim 1.

29. The container according to claim 28, wherein the metallized film layer faces the inside of the container.
